(19) United States
(12) Patent Application Publication
(10) Pub. No.: US 2014/0113797 A1
(43) Pub. Date: Apr. 24, 2014

(54) DEVICE AND METHOD FOR CUTTING BRITTLE MEMBER AND CUT-OUT BRITTLE MEMBER

(71) Applicant: IHI Corporation, Tokyo (JP)

(72) Inventors: Junichi YAMADA, Tokyo (JP); Norihito Kawaguchi, Tokyo (JP); Yoshiyuki Wada, Tokyo (JP); Tomoo Kusumi, Tokyo (JP); Noriaki Hasegawa, Tokyo (JP); Yuichiro Nakayama, Tokyo (JP); Toshiaki Saitou, Tokyo (JP)

(73) Assignee: IHI Corporation, Tokyo (JP)

(21) Appl. No.: 14/139,950

(22) Filed: Dec. 24, 2013

Related U.S. Application Data
(63) Continuation of application No. PCT/JP12/66118, filed on Jun. 25, 2012.

(30) Foreign Application Priority Data
Jun. 28, 2011 (JP) 2011-143035

(51) Int. Cl. C03B 33/09

(52) U.S. Cl. CPC C03B 33/091
USPC 501/11; 65/355; 65/112

(57) ABSTRACT

A device for cutting a brittle member such as a glass is comprised of a laser oscillator configured to radiate a laser beam through a first space onto a first region on the brittle member; a cooling nozzle configured to expel a cooling medium onto a second region distinct from the first region on the brittle member; a baffle so disposed as to leave a gap between the member and the baffle and to have the first region not enclosed by the baffle, and so directed as to deflect a flow of a splash and a mist originating in the second region away from the first region; and a gas nozzle configured to expel a gas toward the gap.

### CROSS-REFERENCE TO RELATED APPLICATIONS

This application is a Continuation application of PCT International Application No. PCT/JP2012/066118 (filed Jun. 25, 2012), which is in turn based upon and claims the benefit of priority from Japanese Patent Application No. 2011-143035 (filed Jun. 28, 2011), the entire contents of which are incorporated herein by reference.

### BACKGROUND OF THE INVENTION

1. Field of the Invention

The present invention relates to a device and a method for cutting a brittle member and a cut-out brittle member.

2. Description of the Related Art

Brittle members such as glass plates could be cut not by a cutting tool but by applying thermal shock thereto. When a local heating means such as a laser beam for example is used to apply heat a glass plate and a cooling medium is then expelled onto regions where the local heating is given to create thermal shock therein, the regions given the thermal shock start to cleave. Thus, if a region that is irradiated with a laser beam is properly made close to a region that is subject to expulsion of a cooling medium and a glass plate is fed from the former region to the latter region, a thermally shocked region in the glass plate extends in the form of a line, thereby the glass plate can be cut along the line.

Japanese Patent Application Laid-open No. 2008-49375 discloses a related art.

### SUMMARY OF THE INVENTION

A splash or a mist of the cooling medium, or a waste fluid flowing on a glass plate, when intruding into a region where a laser beam passes, absorb the laser beam. Therefore it is required to regulate output power of the laser oscillator in order to compensate the loss by the absorption. This regulation increases effort in process control and raises necessity for a higher-power laser oscillator.

This invention has been achieved in view of the aforementioned problems. According to a first aspect of the present invention, a device for cutting a brittle member such as a glass is comprised of a laser oscillator configured to radiate a laser beam through a first space onto a first region on the brittle member; a cooling nozzle configured to expel a cooling medium onto a second region distinct from the first region on the brittle member; a baffle so disposed as to leave a gap between the member and the baffle and to have the first region not enclosed by the baffle, and so directed as to deflect a flow of a splash and a mist originating in the second region away from the first region; and a gas nozzle configured to expel a gas toward the gap.

According to a second aspect of the present invention, a method for cutting a brittle member is comprised of radiating a laser beam through a first space onto a first region on the brittle member; expelling a cooling medium through a cooling nozzle onto a second region distinct from the first region on the brittle member; directing a baffle so disposed as to leave a gap between the member and the baffle and to have the first region not enclosed by the baffle so as to deflect a flow of a splash and a mist originating in the second region away from the first region; and expelling a gas through a gas nozzle toward the gap.

### BRIEF DESCRIPTION OF DRAWINGS

FIG. 1A is a general side view of a cutting device according to an embodiment of the present invention.

FIG. 1B is a plan view of a member to be cut, which illustrates a region irradiated with a laser beam and a cooling region.

FIG. 2 is a general side view of a cutting device according to a modified embodiment.

FIG. 3A is a general side view of a cutting device according to another modified embodiment.

FIG. 3B is a plan view of a member to be cut, which illustrates an arrangement of a baffle as being superimposed on a region irradiated with a laser beam and a cooling region.

FIG. 4 is a general side view of a cutting device according to still another modified embodiment.

FIG. 5A is a plan view of an example of an arrangement of a member to be cut, a laser oscillator and a gas nozzle.

FIG. 5B is a plan view of another example of an arrangement of a member to be cut, a laser oscillator and a gas nozzle.

### DETAILED DESCRIPTION OF THE EXEMPLARY EMBODIMENTS

Exemplary embodiments of the present invention will be described hereinafter with reference to the appended drawings.

A device according to the present embodiment is preferably applicable to cutting of a glass plate but is of course also applicable to cutting of any other brittle member. The descriptions hereinafter exemplify a case in which a glass plate 2 is cut but the exemplified case is no more than an example and not limiting to the present invention.

Further, in the descriptions hereinafter, in general, the term “splash” means droplets having a scattering nature, and the term “mist” includes a fog and fine droplets close to a fog and means such a substance having a drifting nature.

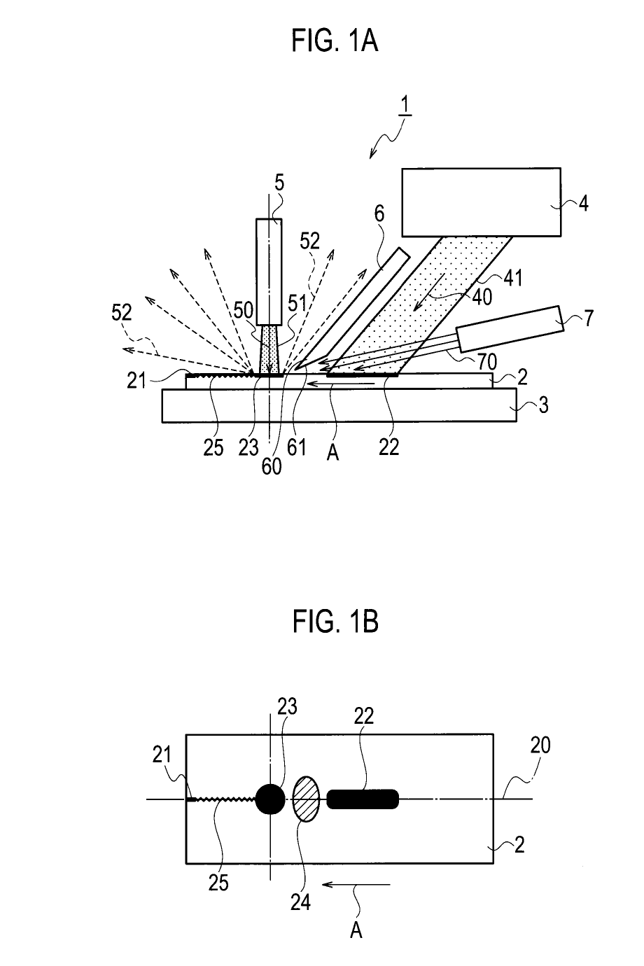

Referring to FIGS. 1A, 2, 3A and 4, any of devices 1,1A,1B,1C for cutting a glass plate 2 according to the present invention is comprised of a table 3 supporting the glass plate 2 thereon, a laser oscillator 4 for radiating a laser beam onto the glass plate 2, a cooling nozzle 5 for expelling a cooling medium, a baffle (a flow rectifying plate) 6,6t, or 8, and a gas nozzle 7 for expelling a gas. In the device 1C, the baffle 6t also serves as a gas nozzle.

The table 3 is comprised of a proper conveying means for feeding the glass plate 2 in an arrow A for example. Or, the glass plate 2 may be fixed and instead the laser oscillator 4, the cooling nozzle 5 and the other elements may be fed in a direction opposed to the arrow A. Furthermore, any levitating conveyor device may be used if a distance relative to the laser oscillator 4 is held stable. In the following descriptions, merely a case in which the glass plate 2 is fed in the direction of the arrow A is taken for an example but it is no more than a matter of convenience of explanation. Any of these modifications will occur.

To the laser oscillator 4 applicable is a carbon dioxide laser oscillator having an output power of from 100 to several hundreds watts, but any other laser oscillators having output powers in other power ranges or of any other construction may be applicable thereto. The laser oscillator 4 is preferably so arranged as to radiate a laser beam 40 in an oblique direction forming a proper angle relative to the glass plate 2 so as to keep away from reflection of the laser beam.

The laser beam 40 may have a considerable width and therefore a region 41 (first space) where the laser beam 40 passes is illustrated to have a considerable width in the drawings. Further the reference numeral 22 is a region (first region) that is irradiated with the laser beam 40 on the glass plate 2.

The cooling nozzle 5 is a nozzle for expelling a cooling medium 50. As the cooling medium 50 usable is water for example, use of which is advantageous in its low cost and easy availability. Alternatively, in light of efficiency of cooling or such, alcohol, dry ice, nitrogen, argon or such may be used instead of water. These may be used in any form of a liquid phase, a vapor phase, or a fog transported with any gas.

The cooling medium 50 inherently having a considerable width 51 is expelled onto a region 23 (second region) on the glass plate 2. Referring to FIG. 1B, the region 23 exposed to expulsion of the cooling medium 50 is distinct from the region 22 irradiated with the laser beam 40 and falls apart therefrom in the direction of the arrow A.

As the glass plate 2 is fed in the direction of the arrow A, it is heated at the region 22 and is immediately thereafter cooled at the region 23, thereby being thermally shocked. A score is in advance given to an end of the glass plate 2 by a diamond cutter or such, which functions as a starting point of cutting. If the glass plate 2 is fed so as to make a cutting preset line 20 pass through both the regions 22 and 23, the thermal shock is, as running along this line, given to the glass plate 2. The glass plate 2 is thereby cut along the cutting preset line 20 as shown by a solid line 25 in the drawing.

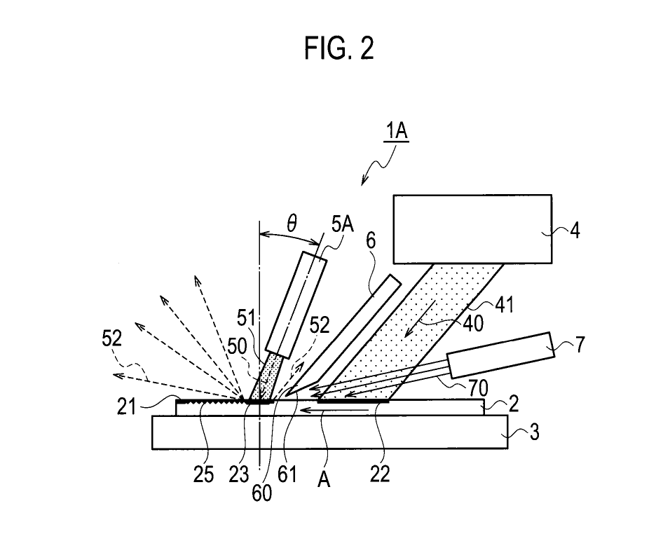

The cooling nozzle 5 may be, as shown in FIG. 1A, so arranged as to expel the cooling medium 50 in a direction perpendicular to a surface of the glass plate 2. Alternatively, the cooling nozzle 5 may be, as shown in FIG. 2, so arranged as to expel the cooling medium 50 in a direction oblique to a surface of the glass plate 2 in an angle θ, where θ is any proper angle greater than 0 degrees and less than 90 degrees.

The expelled cooling medium 50, after colliding with the glass plate 2, comes to be a splash in part and a mist in part and then scatters around as shown in a reference numeral 52 in the drawing. In order to deflect such a flow 52 of the splash or the mist from the region 22 irradiated with the laser beam 40, the baffle 6 is disposed. While the baffle 6 may be properly disposed in light of this purpose, the disposition may be selected from any locations in between the region 22 and the region 23 as shown in the drawing, or in between the region 41 and the region 51. Further, while the baffle 6 may be properly inclined in light of the purpose to deflect the flow of the splash or the mist, any slope should be selected so as not to interfere with the region 41 where the laser beam 40 passes.

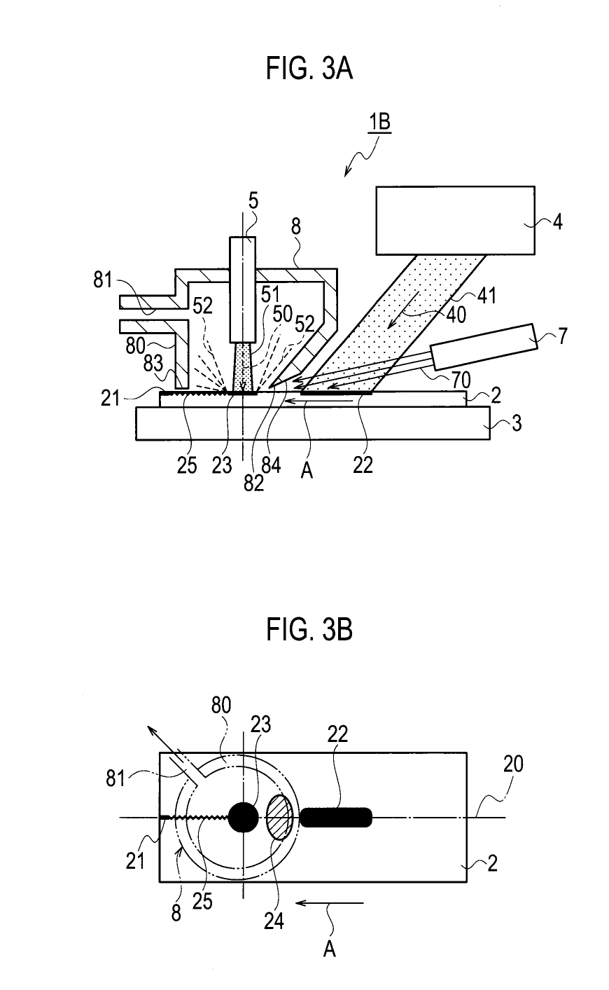

The baffle 6 is a flat plate or a curved plate for example. In a case where the baffle 6 is made to be a curved plane, the curved plane may curve around so that one end meets the other end, thereby forming a closed cylinder as shown in FIG. 3B. Or the baffle 6 may be a curved plate that is not closed at any periphery. The region 41 where the laser beam 40 passes is, in any case, not enclosed by the baffle 6 and therefore both sides, and preferably the rear side (the side opposed to the arrow A) as well, of the region 41 is opened. According to this construction, the baffle 6 does not bar heat by the laser beam 40 from radiating outward. More specifically, the heat by the laser beam 40 does not stay around the region 22 and thus heat affection is not out of focus but is brought into focus on the region 22. This is advantageous in making the cutting line 25 precisely along the cutting preset line 20.

It may occur of course that any means for blocking the laser beam is provided at a position sufficiently distant from the region 22 or the region 41 in order to protect those working around or ambient devices.

To avoid contact of the baffle 6 with the glass plate 2, any proper gap is held in between an end 60 of the baffle 6, which is close to the glass plate 2, and the glass plate 2. To prevent a splash or a mist from leaking out through the gap, the gas nozzle 7 is so directed as to expel a gas 70 toward the gap. A region where the gas 70 is directed is in between the region 22 and the region 23 and is also a region to which a reference numeral 24 is attached in FIG. 1B.

To what the nozzle 7 expels applicable is a usual air but any other gas such as nitrogen and argon may be instead used.

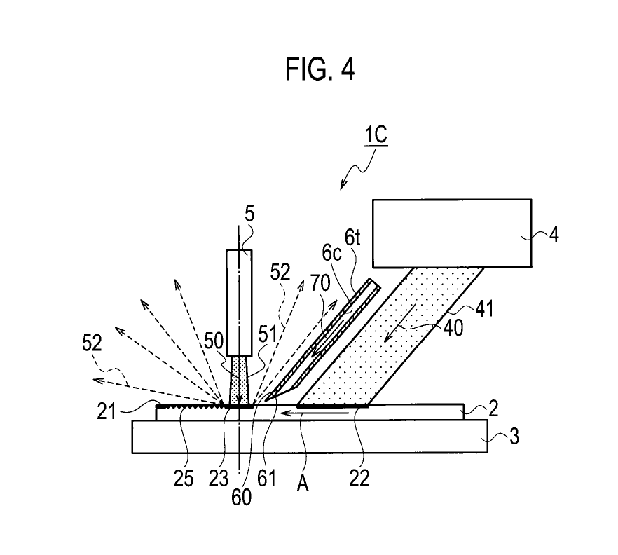

The gas nozzle may be alternatively embedded in a baffle as shown in FIG. 4. A hollow baffle 6t is capable of conducting the gas 70 through a cavity 6c therein and thus functions as a gas nozzle as well. The expelled gas 70 is, as with the case described above, expelled to the gap under the baffle 6t and also the region between the region 22 and the region 23. In this case, a gas nozzle 7 may be further additionally provided, or may be omitted as in the drawing.

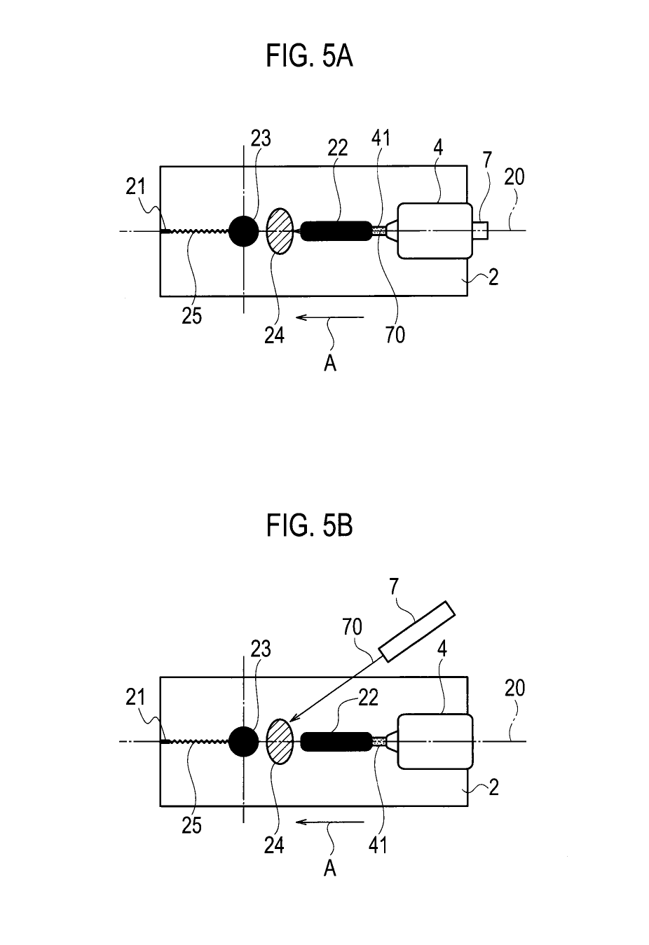

Alternatively, the gas nozzle 7 may be placed in an arrangement in that the gas 70 is directed in a direction from the region 22 toward the region 23 as shown in FIG. 5A. This arrangement is advantageous in getting the spray or the mist away from the region 22. Still alternatively, the gas nozzle 7 may be placed in an arrangement in that the gas 70 is directed in a direction forming an angle greater than 0 degrees and less than 90 degrees relative to a direction from the region 22 toward the region 23 as shown in FIG. 5B. This arrangement is advantageous in processing the cooling medium 50 after use as waste fluid because the gas blows off the cooling medium 50 on the glass plate 2 toward the side thereof. Further this arrangement makes intrusion of the gas under the glass 2 unlikely. This arrangement is advantageous in that, in particular in a case where a levitating conveyor device is used as a conveyor means, the gas 70 intruding under the glass plate 2 does not disturb height of the glass plate 2.

An end 60 of the baffle 6 opposed to the glass 2, or an end 82 of the cylindrical body 8 opposed to the glass 2, may have a taper 61 or 84 as shown in FIGS. 1A, 2, 3A and 4. The taper 61 or 84 conducts the gas 70 toward the region 23 and in particular removes the cooling medium 50 away from the glass plate 2.

In a case where the baffle is formed to be a cylindrical body 8 as shown in FIGS. 3A, 3B, upper part thereof may be closed as well. Even in this case lower part thereof is opened as illustrated, thereby holding a gap between the lower end 83 and the glass plate 2. In a case where the upper part is closed, the cooling nozzle 5 may be in close contact with the cylindrical body 8. Further in this case, a through-hole 81 may be provided on a side wall or any other part. The through-hole 81 is helpful in exhausting the spray or the mist to the exterior. Or, to the through-hole 81 may be provided a suction device. Both are effective in preventing the flow 52 of the splash or the mist from leaking to the region 22.

Positions and slopes of the laser oscillator 4, the cooling nozzle 5, the baffle 6 and the gas nozzle 7 may not be fixed. To regulate them, any regulation means such as micrometers may be provided.

To retrieve the cooling medium after use, any recycling circuit may be provided, thereby recycling the cooling medium.

Steps for cutting the glass plate 2 by means of any of the aforementioned devices 1, 1A, 1B and 1C will be described hereinafter. A score 21 is as described above made on one end or any point on the cutting preset line 20. The glass plate 2 is fixed on the table 3 of any of the devices 1, 1A, 1B and 1C. The glass plate 2 is, on the region 22 thereof, irradiated with the laser beam 40 with being fed in the direction shown by the arrow A under a controlled speed, and is then, on the region 23, subject to expulsion of the cooling medium 50. In synchronization with the irradiation with the laser beam 40 or the expulsion of the cooling medium 50, the gas 70 is expelled toward the gap under the baffle 6. Then heating and cooling instantly occur along the cutting preset line 20 on the glass plate 2 so that thermal shock is given to the glass plate 2 and mainly generates tensile stress therein. The tensile stress alone, or in combination with secondary stress application by bending the glass plate along the cutting preset line 20 for example, causes crevice formation and its progress along the cutting preset line 20, thereby the glass plate 2 breaks along the cutting present line 20.

According to the aforementioned embodiment, due to the action of the baffle and the gas expulsion, the spray or the mist of the cooling medium does not intrude into the region where the laser beam passes or radiates on. Therefore the laser beam is prevented from being absorbed in the cooling medium. It is unnecessary to regulate output power of the laser oscillator in order to compensate the loss by the absorption. The present embodiment reduces effort in process control and does not require a higher-power laser oscillator.

Although the invention has been described above by reference to certain embodiments of the invention, the invention is not limited to the embodiments described above. Modifications and variations of the embodiments described above will occur to those skilled in the art, in light of the above teachings.

### INDUSTRIAL APPLICABILITY

A device for cutting a brittle member, which reduces loss of laser beam power, is provided.

1. A device for cutting a brittle member, comprising:
a laser oscillator configured to radiate a laser beam through a first space onto a first region on the brittle member;
a cooling nozzle configured to expel a cooling medium onto a second region distinct from the first region on the brittle member;
a baffle so disposed as to leave a gap between the member and the baffle and to have the first region not enclosed by the baffle, and so directed as to deflect a flow of a splash and a mist originating in the second region away from the first region; and
a gas nozzle configured to expel a gas toward the gap.

2. The device of claim 1, wherein the baffle comprises a tapered end directed toward the gap.

3. The device of claim 1, wherein the baffle is one selected from the group consisting of a flat plate, a non-closed curved plate, and a cylindrical plate so dimensioned as to enclose the cooling nozzle.

4. The device of claim 1, wherein the gas nozzle is placed in any arrangement selected from the group consisting of an arrangement to direct the gas from the first region toward the second region, and an arrangement to direct the gas in a direction forming an angle greater than 0 degrees and less than 90 degrees relative to a direction from the first region toward the second region.

5. The device of claim 1, wherein the gas nozzle is embedded in the baffle.

6. The device of claim 1, wherein the cooling nozzle is so disposed as to expel the cooling medium in any direction selected from the group consisting of a direction perpendicular to a surface of the member, and a direction oblique to a surface of the member in an angle greater than 0 degrees and less than 90 degrees.

7. A method for cutting a brittle member, comprising:
radiating a laser beam through a first space onto a first region on the brittle member;
expelling a cooling medium through a cooling nozzle onto a second region distinct from the first region on the brittle member;
directing a baffle so disposed as to leave a gap between the member and the baffle and to have the first region not enclosed by the baffle so as to deflect a flow of a splash and a mist originating in the second region away from the first region; and
expelling a gas through a gas nozzle toward the gap.

8. The method of claim 7, further comprising:
providing the baffle with a tapered end directed toward the gap.

9. The method of claim 7, further comprising:
forming the baffle to be one selected from the group consisting of a flat plate, a non-closed curved plate, and a cylindrical plate so dimensioned as to enclose the cooling nozzle.

10. The method of claim 7, further comprising:
placing the gas nozzle in any arrangement selected from the group consisting of an arrangement to direct the gas from the first region toward the second region, and an arrangement to direct the gas in a direction forming an angle greater than 0 degrees and less than 90 degrees relative to a direction from the first region toward the second region.

11. The method of claim 7, further comprising:
embedding the gas nozzle in the baffle.

12. The method of claim 7,
disposing the cooling nozzle so as to expel the cooling medium in any direction selected from the group consisting of a direction perpendicular to a surface of the member, and a direction oblique to a surface of the member in an angle greater than 0 degrees and less than 90 degrees.

13. A brittle member cut by any method as recited in claim 7.
